(19) United States
(12) Patent Application Publication
(10) Pub. No.: US 2013/0321656 A1
(43) Pub. Date: Dec. 5, 2013

(54) WIRELESS NETWORK CONNECTED CAMERA POSITIONING SYSTEM

(71) Applicant: Hoverfly Technologies, Inc., Oviedo, FL (US)

(72) Inventors: Alfred D. Ducharme, Oviedo, FL (US); Daniel Burroughs, Casselberry, FL (US); Stacey L. Ducharme, Oivedo, FL (US); George Richard Sapp, Orlando, FL (US)

(73) Assignee: Hoverfly Technologies, Inc., Oviedo, FL (US)

(21) Appl. No.: 13/857,602

(22) Filed: Apr. 5, 2013

Related U.S. Application Data
(60) Provisional application No. 61/621,152, filed on Apr. 6, 2012.

(51) Int. Cl. H04N 5/232

(52) U.S. Cl. CPC H04N 5/23203
USPC 348/211.1

(57) ABSTRACT

A system for controlling a gimbal has a gimbal controller. The gimbal controller has a communication device with a unique communication address and a microcontroller communicating with the communication device. The gimbal controller receives instructions addressed to the communication address and outputs one or more control outputs for controlling movement of a gimbal about at least one axis in response to receipt of the instructions.

### CROSS REFERENCE TO RELATED APPLICATION(S)

This application claims priority to Provisional Patent Application No. 61/621,152, filed Apr. 6, 2012, and is incorporated herein as set forth in its entirety.

### BACKGROUND OF THE INVENTION

This invention is directed to the control of a camera gimbal, and in particular, a system for remotely controlling the gimbal of a stabilized camera.

For a number of reasons, cameras are mounted on platforms. These platforms can be stationary, such as a tripod, or moving, such as on a helicopter or other aerial carrier, or even on tracks as well known in the movie industry to “follow” a shot. The cameras are supported on these platforms with mechanical positioning systems.

This type of mechanical camera positioning system is typically referred to as a gimbal mount or simply gimbal. Gimbal camera mounts 10 are an essential part of both photographic and cinematography. These systems are used for terrestrial filming while mounted on a tripod mount, pole or arm. In addition, gimbals are used for filming from aerial platforms where the absence of axis stabilization would yield unusable video and still shots.

As seen in FIG. 1, gimbal 10 may include a series of mounts 5, 7, 9 to support a camera 20 in three directions; capable of motion along three axes; pan, roll and tilt. Each respective mount is fixed in one axis of rotation. Axis 5 is fixed along the horizontal axis. Mount 7 is fixed relative to the tilt axis, but may be capable of movement about the pan axis but not the roll axis. Mount 9 is fixed in the pan axis, but is capable of movement about the tilt axis. Camera 20 in this embodiment is supported by mount 9.

Gimbal 10 includes electro-mechanical movement devices 12a, 12b, 12c such as a servo motor, stepper motor, or magnetic actuator capable of moving a respective mount about at least one axis of rotation. These electro-mechanical devices 12a, 12b, 12c allow for motorized movement of the camera to alter the field-of-view of the camera.

Existing gimbal systems utilize an electro-mechanical joystick assembly specifically configured to control a particular camera 20 to actuate the speed and direction of the motors 12a, 12b, 12c to change the angle of camera 20 about each axis. More sophisticated electronic controllers can automate certain functions to maintain particular orientations. An example would be to allow the automated controller to alter the roll axis so that the horizon as seen by camera 20 is maintained level to the ground in view regardless of orientation of the platform. This sophisticated automation can also be extended to all three axis to maintain the line-of-sight of camera 20 while the angle of the host platform changes with time.

The prior art gimbal camera has been satisfactory, however in stabilized camera environments, particularly those stabilized cameras mounted in aerial platforms, control of the gimbal is often done through a joystick or other hand control. The joystick communicates with the controller. However, only the specific joystick configured to communicate with the controlled gimbal can communicate with each other. In other words, without significant reengineering, a single joystick cannot be used to control a number of different gimbals; and conversely the gimbal 10 cannot be controlled without an expensive, sophisticated joystick.

Accordingly, a device which overcomes the shortcomings of the prior art is desired.

### SUMMARY OF THE INVENTION

A system for controlling a gimbal includes a gimbal controller operatively coupled to the gimbal. The microcontroller provides one or more control outputs for controlling movement of the gimbal in one or more directions. The system includes a communication device having a unique communication address. The microcontroller receives instructions addressed to the communication address and outputs control outputs in response thereto.

In a preferred embodiment the unique communication address is an internet protocol address. The control outputs control movement of the gimbal in a roll axis, tilt axis, or pan axis. In another embodiment of the invention, the gimbal controller may additionally receive input from a joystick controller.

### BRIEF DESCRIPTION OF THE DRAWINGS

For a fuller understanding of the invention, reference is had to the following description taken in connection with the accompanying drawings in which:

FIG. 1 is a perspective view of a gimbal and camera constructed in accordance with the prior art; and

FIG. 2 is a schematic drawing of a system for controlling the gimbal in accordance with the invention.

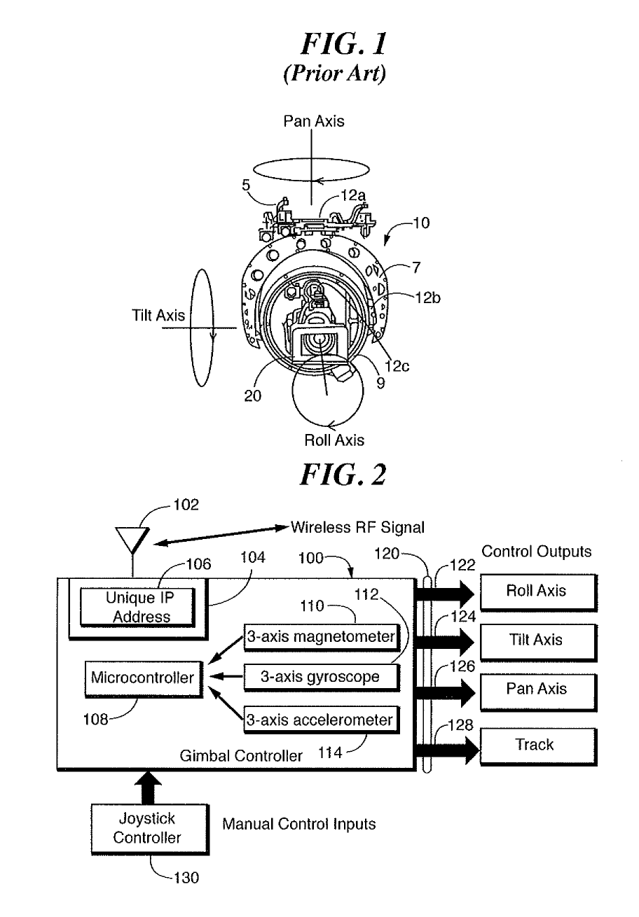

### DETAILED DESCRIPTION OF THE INVENTION

Reference is now made to FIG. 2 which shows a gimbal controller 100 constructed in accordance with the invention. Electronic gimbal controller 100 includes motion sensors, in particular by way of non-limiting example, digital gyroscope 112, accelerometer 114 and magnetometers 110 for detecting motion of gimbal 10 and/or camera 20. Outputs from motion sensors 110, 112, 114 are used to stabilize and control a gimbal 10. In addition, a communication device 104, which may be formed as an integrated circuit with a microcontroller 108 is used to wirelessly transmit and receive control and configuration information.

The intelligence of gimbal controller 100 is provided by a microcontroller 108. 3-axis magnetometer 110 is a sensor that provides information to the microcontroller as to the orientation of gimbal 10 with respect to the Earth's magnetic field. 3-axis gyroscope sensor 112 detects changes in the rate of rotation of gimbal 10 about the roll, tilt, and pan axis. 3-axis accelerometer 114 senses the acceleration forces experienced by gimbal 10 along the roll, tilt, and pan axis. Microcontroller 108 combines the information provided by these three sensors to provide an accurate estimate of the current position and movement of gimbal 10.

Gimbal controller 100 is fixed to the gimbal mount of gimbal 10 and thereby has the ability to recognize changes in movement of gimbal 10. The movement of gimbal 10 closely coordinates with movement of camera 10, but in a preferred embodiment sensors 110, 112, 114 may be mounted directly on camera 20.

Microcontroller 108 generates control signals 120 for various types of electro-mechanical motorized devices such as devices 12a, 12b, 12c which are used to alter the angle of the roll, tilt, and pan axis of gimbal 10. These are indicated in FIG. 2 as outputs 120 from the gimbal controller 100.

In addition to the gimbal axis outputs, gimbal controller 100 outputs control signals, such as control signal 128 that control the movement of the host platform (not shown) , such as an aerial platform, or a cart on a truck, to track an object (move along an axis) by way of example. Additional examples of an output 120 may be control signal outputs that control the operation of camera 20 such as shutter and zoom control signals,

Gimbal controller 100 also includes a communication device 104, formed, in one non-limiting example, as an integrated circuit with microcontroller 108 to send and receive information on a wireless network utilizing an antenna 102. Each gimbal controller 100 is assigned a unique communication address, such as an internet protocol (“IP”) address. Providing gimbal controller 100 with a unique internet address allows the remote control of numerous gimbal mounts 10 connected to a common or bridged wireless network from a single device. The internet address may be an ad hoc address or part of an existing network. In a preferred, but non-limiting embodiment, the unique address is a Mac ID. This allows a portable device such as a smart phone to communicate with and provide control signals to gimbal controller 100.

A typical application would be the filming of a sporting event where the line-of-sight of multiple cameras can be controlled by a single person operating a control system also connected to the network.

Utilizing output signals 120, gimbal controller 100 has the ability to automatically control the roll, tilt, and pan axis of gimbal 10 to maintain a fixed line-of-sight for camera 20, during the typical operation of gimbal 10, manual control of the line-of-sight is often required. However, a joystick controller 130 may also be used to input control information to alter the fixed position of the gimbal 10 and camera 20. Microcontroller 108 has the ability to decipher and utilize input commands from joystick controller 130 and produce outputs 120 in response thereto. The network connectivity of gimbal controller 100, addressable at an IP address, allows control and manipulation of a gimbaled camera using a mobile communication device. An example would be a smart phone application with a virtual joystick to provide manual control of the line-of-sight of the camera. Sophisticated physical joysticks are no longer needed.

The smart phone application would include several control features for typical photography and cinematography applications. In the simplest example a virtual joystick would be used to control the roll, tilt, and pan axis of the camera. In smart phones incorporating movement sensors such as accelerometers, magnetometers, and gyroscopes, the movement of the phone in free space could be used to control the movement of the gimbal. This removes the need for sophisticated dedicated joysticks as used in the art.

Another application would be time-lapse photography where a picture is taken at regular intervals over a long span of time. The smart phone application would be used to choose the start and stopping orientation of the gimbal, interval between pictures, and overall length of time. In addition, a movement choreography feature could be used where the user simply moves the smart phone in free space indicating the movement of the gimbal and then specifies time duration for the movement. Gimbal movement can be pre-planned much like a flight plan ahead of the shoot.

Thus, while there have been shown, described and pointed out, novel features of the present invention as applied to preferred embodiments thereof, it will be understood that various omissions and substitutions and changes in the form and details of the disclosed invention may be made by those skilled in the art without departing from the spirit and scope of the invention. It is the intention therefore, to be limited only as indicated by the scope of the claims appended hereto.

It is also to be understood that the following claims are intended to cover all of the generic and specific features of the invention herein described and all statements of the scope of the invention which, as a matter of language, might be said to fall therebetween.

What is claimed as new and desired to be protected by Letters Patent is:

1. A system for controlling a gimbal comprising:
a gimbal controller, the gimbal controller having a communication device with a unique communication address; and
a microcontroller communicating with the communication device, to receive instructions addressed to the communication address, and outputting one or more control outputs for controlling movement of a gimbal about at least one axis in response to receipt of the instructions.

2. The system of claim 1, wherein the address is an Internet protocol address.

3. The system of claim 1, further comprising one or more sensors, for sensing movement of the gimbal and providing a gimbal orientation information to the microcontroller.

4. The system of claim 1, wherein the sensor is at least one of a gyroscope, accelerometer, and magnetometer.

5. The system of claim 1, further comprising at least one electromechanical device for moving the gimbal in response to the one or more control outputs.

6. The system of claim 1, further comprising a host platform, the gimbal being mounted on the host platform, at least one of the control output controlling movement of the gimbal along the control platform.

7. The system of claim 1, wherein the microcontroller outputs an operation control output to control operation of a camera mounted to the gimbal.

8. The system of claim 1, further comprising a portable device, the portable device communicating with the communicating device for sending the instructions addressed to the communication device.

9. The system of claim 8, wherein the portable device is a joystick.

10. The system of claim 8, wherein the portable device is a smart phone.
